(19) United States
(12) Patent Application Publication
(10) Pub. No.: US 2005/0127660 A1
(43) Pub. Date: Jun. 16, 2005

(54) Low friction D-ring or web guide

(75) Inventor: Huiyao Liu, Rochester, MI (US)

Correspondence Address: KEY SAFETY SYSTEMS, INC.;PATENT DEPARTMENT, 7000 NINETEEN MILE ROAD, STERLING HEIGHTS, MI, 48314, US

(73) Assignee: Key Safety Systems, Inc.

(21) Appl. No.: 10/993,506

(22) Filed: Nov. 19, 2004

Related U.S. Application Data
(60) Provisional application No. 60/529,497, filed on Dec. 15, 2003.

(51) Int. Cl. B60R 22/00

(52) U.S. Cl. 280/808; 280/801.1

(57) ABSTRACT

A D-ring or web guide for a seat belt, comprising: a load-absorbing body formed with a seat belt support surface and an opening thereabove and a friction-reducing, thin, flexible synthetic tape configured to be applied to the seat belt support surface, the tape comprising a layer of low friction material with a layer of adhesive applied to a first side of the synthetic tape, the seat belt passing over a side of the tape opposite the first side of the tape which is in contact with the adhesive.

### BACKGROUND AND SUMMARY OF THE INVENTION

This application claims the benefit of U.S. Provisional Application 60/529,497, filed on Dec. 15, 2003. The disclosure of the above application is incorporated herein by reference.

The present invention relates to D-rings or web guides for seat belt systems.

The typical three-point seat belt system 10 secured about an occupant 70 as shown in FIG. 1 comprises a retractor 22 (mounted in the seat or on a vehicle pillar), a seat belt 24, a D-ring (also referred in the art as a Web guide) 26 (often mounted on the B or C-pillar), a tongue 28 and a seat belt buckle 30 (mounted to a seat frame or to the floor). Two such web guides 26 and 26a are shown in FIGS. 2 and 3. Web guides such as 26 and 26a generally include a load-bearing body 32 and a load-bearing seat belt receiving surface 40 formed, for example, from a stamped plate (FIG. 2) or from a wire (FIG. 3). A fastener (not shown) is received through a fastener-receiving opening 42. The seat belt receiving surface 40 is spaced apart from other portions of the D-ring thereby forming a seat belt receiving opening or slot 44. During normal operation and as shown in FIG. 1, the seat belt is received through the D-ring and slides upon surface 40

Those familiar with the design and development of seat belt systems know the contact friction between the D-ring in the seat belt webbing (seat belt) can significantly impact the performance of the system. The friction in the seat belt system defines, in part, the spring constant of the rewind spring that acts on the spool of the retractor and which must generate a spring force sufficiently high to overcome friction in the system and pull or rewind a determinable extended length of seat belt (also referred to as webbing). As can be appreciated, the restoring force of the spring is proportional with the spring constant and as the spring constant increases (with increasing system friction) the inherent force applied by the shoulder belt upon the occupant's shoulder increases.

The prior art has attempted to reduce the contact friction at the D-ring by coating the D-ring with chrome, or with a synthetic or other generally low-friction or slippery material such as an electro-coat or Teflon® (PTFE). The prior art has also suggested constructing a preformed, low friction assembly and snapping this pre-form about the seat belt support surface 40 of the web guide.

It is an object of the present invention to provide an improved D-ring or web guide. Accordingly the invention comprises: a D-ring or web guide for a seat belt, comprising: a load-absorbing body formed with a seat belt support surface and an opening thereabove and a friction-reducing, thin, flexible synthetic tape configured to be applied to the seat belt support surface, the tape comprising a layer of low friction material with a layer of adhesive applied to a first side of the synthetic tape, the seat belt passing over a side of the tape opposite the first side of the tape, which is in contact with the adhesive.

Many other objects and purposes of the invention will be clear from the following detailed description of the drawings.

### BRIEF DESCRIPTION OF THE DRAWINGS

FIG. 1 shows a conventional three-point seat belt system.

FIGS. 2 and 2a show views of a stamped D-ring or web guide.

FIG. 3 shows a D-ring or web guide made of bent wire.

FIG. 4 is a plan view of a section of tape.

FIG. 5 is a cross-sectional view taken through section 5-5 of FIG. 4.

FIGS. 6 and 6a show a thin film applied to the seat belt supporting surface of two different D-rings or web guides.

### DETAILED DESCRIPTION OF THE DRAWINGS

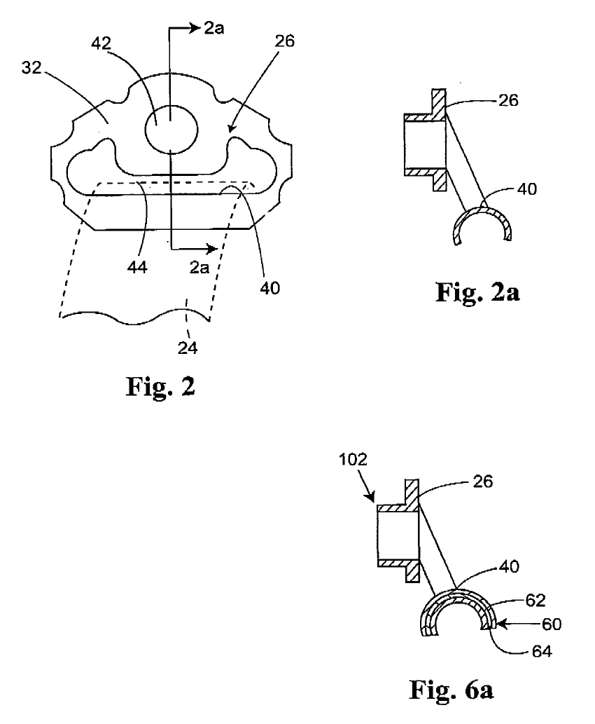

Reference is again briefly made to FIGS. 2 and 2a, which show a first type of known web guide 26 made from a one-piece steel stamping. This web guide includes a seat belt or web support surface 40 across which a seat belt slides. This web guide 26 includes a narrow opening 44 to receive the seat belt or webbing 24 (shown in phantom line).

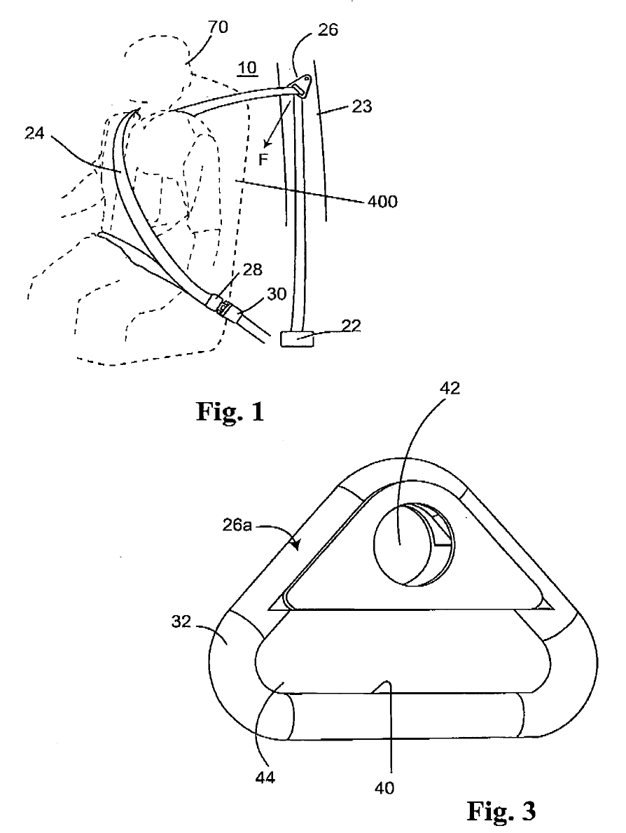

FIG. 3 shows a bent wire 43 formed into a generally triangular shape. This web guide 26a also includes a seat belt support surface 40 across which the seat belt 24 slides. Characteristic of the bent wire type of web guide is that the web receiving opening 44 is larger than the corresponding opening shown in FIG. 1. As is known in the art, the web receiving opening 44 can be reduced in size by snapping an insert (not shown) to those portions of the web guide proximate the opening 44.

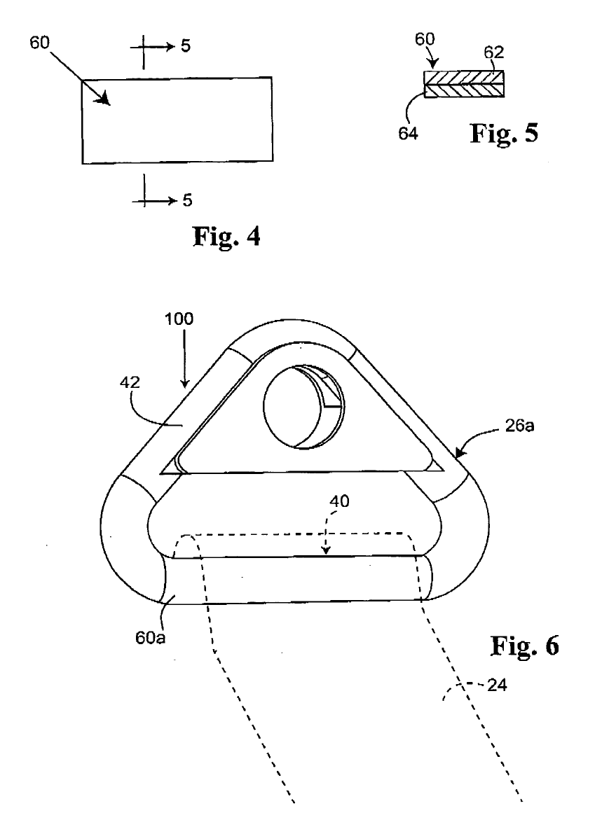

The present invention proposes forming a flat, flexible, and generally rectangular tape (or tape segment) or applique 60 shown in FIGS. 4 and 5 and applying this tape 62 to the support surface 40 of the D-ring. The thickness of the film 62 and the adhesive layer 64 has been exaggerated in FIG. 5 (as well as in FIG. 6). The seat belt or webbing 24 will slide over this tape or applique 60. The tape or applique 60 comprises a low friction layer formed by a polymeric thin film 62 with an adhesive layer 64 applied to one side of the film 62; the other side of the film supports the seat belt. In the preferred embodiment the thin film 62 is made using a lonomer or Acetal thin film, a PTFE (Teflon or Teflon-like) film or an ultra-high molecular weight polyethylene (UHMWPE) film. The adhesive layer 64 must be able to adhere to the low friction surface of the thin film 62 as well as being able to be adhered to the metallic support surface 40 of the D-ring. In the preferred embodiment the adhesive is silicone or acrylic. Further, in the preferred embodiment of the invention the thickness of the fluoropolymer is approximately 0.13 mm while the thickness of the adhesive layer is approximately 0.04 mm. The combination of film and adhesive layer provides a 180 degree peel strength of about 0.6 lbs/in.

Reference is briefly made to FIGS. 6 and 6a, which show a web guide 100 (similar to web guide 26) of the present invention in which a segment 60a of the low friction tape 60 has been cut to length and applied to the support surface 40 of the D-ring or web guide 100. In the cross-sectional view in FIG. 6a, the low friction tape 60 (or tape segment 60a) is shown applied to the support surface 40 of web guide 102 (similar to web guide 26).

In carrying out the preferred embodiment of the invention, it is envisioned the tape will be supplied in a roll; the tape segment 60a is subsequently cut to length as needed and applied to the support surface. The desired length of the tape segment 60a should be sufficient to cover the flat portion of the support surface 40 (and might be slightly less than the length of the support surface 40).

In an alternate embodiment of the invention the adhesive layer 64 is not used and the low friction film is transfer molded, in-line molded or insert molded to support surface 40 of the D ring.

Many changes and modifications in the above-described embodiment of the invention can, of course, be carried out without departing from the scope thereof. Accordingly, that scope is intended to be limited only by the scope of the appended claims.

1. A D-ring or web guide for a seat belt, comprising: a load-absorbing body formed with a seat belt support surface and an opening thereabove and a friction-reducing, thin, flexible synthetic tape configured to be applied to the seat belt support surface, the tape comprising a layer of low friction material with a layer of adhesive applied to a first side of the synthetic tape, the seat belt passing over a side of the tape opposite the first side of the tape which is in contact with the adhesive.

2. The D-ring or web guide as defined in claim 1 wherein the synthetic tape is made from one of a lonomer film, an Acetal film, a PTFE film or an ultra high molecular weight polyethylene (UHMWPE) film.

3. The D-ring or web guide as defined in claim 2 wherein the thickness of the film is about 5.0 mil (0.13 mm).

4. The D-ring or web guide as defined in claim 1 wherein the adhesive layer is silicone or acrylic.

5. The D-ring or web guide as defined in claim 4 wherein the thickness of the adhesive layer is about 1.5 mil (0.04 mm).

6. The D-ring or web guide as defined in claim 4 wherein the adhesive layer provides a 180 degree peel strength of about 0.6 lbs/in.

7. A method of making a D-ring or web support comprising the steps of:
a) providing a load-bearing member with a seat belt support surface;
b) providing a synthetic film and
c) adhesively bonding the film to the seat belt support surface.
